(19) United States
(12) Patent Application Publication
(10) Pub. No.: US 2025/0225701 A1
(43) Pub. Date: Jul. 10, 2025

(54) VIDEO PROCESSING METHOD AND APPARATUS, DEVICE AND STORAGE MEDIUM

(71) Applicant: Beijing Zitiao Network Technology Co., Ltd., Haidian District, Beijing (CN)

(72) Inventors: Xubin Zhou, Beijing (CN); Junyu Diao, Beijing (CN)

(21) Appl. No.: 18/854,177

(22) PCT Filed: Mar. 29, 2023
(86) PCT No.: PCT/CN2023/084568

§ 371 Date: Oct. 4, 2024

(30) Foreign Application Priority Data
Apr. 8, 2022 (CN) 202210369833.X

(51) Int. Cl. G06T 11/60; G06F 3/04845; G06T 7/20; G06T 11/00; G06V 40/16

(52) U.S. Cl. CPC G06T 11/60; G06F 3/04845; G06T 7/20; G06T 11/001; G06V 40/161

(57) ABSTRACT

Embodiments of the present disclosure relate to a video processing method and apparatus, a device and a medium, the method includes: obtaining a moving track of display positions mapped into a target area of an original video, based on a moving track of positions of a control object; generating a render texture according to the moving track of the display positions; determining a rendering area according to a preset sticker base image above the target area and the render texture; and displaying sticker content in the sticker base image within the rendering area to generate a target video.

### CROSS-REFERENCE TO RELATED APPLICATIONS

The present disclosure is based on and claims the benefit of priority to the CN application No. 202210369833.X filed on Apr. 8, 2022, which is hereby incorporated by reference in its entirety into the present disclosure.

### TECHNICAL FIELD

The present disclosure relates to the technical field of video processing, in particular to a video processing method, device, apparatus and medium.

### BACKGROUND ART

With rapid development of Internet technology and smart devices, interaction between users and smart devices is becoming more and more diversified.

Smart devices can provide users with an interactive way of doodling and applying textures, to attract users, but at present, this way is usually screen doodling, and users are supported to draw freely on the screen, with completed doodles displayed on-screen or applied as textures to objects. In this way, users can only doodle in a fixed screen range, which is less flexible and less interactive.

### SUMMARY OF THE INVENTION

In order to solve the technical problem, the present disclosure provides a video processing method, device, apparatus and medium.

Some embodiments of the present disclosure provide a video processing method, the method comprising:

obtaining a moving track of display positions mapped into a target area of an original video, based on a moving track of positions of a control object;
generating a render texture according to the moving track of the display positions;
determining a rendering area according to a preset sticker base image above the target area and the render texture; and
displaying sticker content in the sticker base image within the rendering area to generate a target video.

Some embodiments of the present disclosure further provide a video processing device, the device comprising:

a track module configured to obtain a moving track of display positions mapped into a target area of an original video, based on a moving track of positions of a control object;
a texture module configured to generate a render texture according to the moving track of the display positions;
an area module configured to determine a rendering area according to a preset sticker base image above the target area and the render texture; and
a video module configured to display sticker content in the sticker base image within the rendering area to generate a target video.

Some embodiments of the present disclosure further provide an electronic apparatus comprising a processor; and a memory for storing an instruction executable by the processor; wherein the processor is configured to read the executable instruction from the memory and execute the instruction to implement the video processing method provided by the embodiments of the present disclosure.

Some embodiments of the present disclosure further provide a computer-readable storage medium in which a computer program is stored, and the computer program is configured to execute the video processing method provided by the embodiments of the present disclosure.

### BRIEF DESCRIPTION OF THE DRAWINGS

The above and other features, advantages and aspects of embodiments of the present disclosure will become more apparent by referring to the following preferred embodiments in conjunction with the accompanying drawings. Throughout the drawings, identical or similar reference numerals denote identical or similar elements. It should be understood that the drawings are schematic, and units and elements are not necessarily drawn to scale.

FIG. 1 is a flow chart of a video processing method provided by some embodiments of the present disclosure;

FIG. 2 is a schematic diagram of a target area provided by some embodiments of the present disclosure;

FIG. 3 is a flow chart of another video processing method provided by some embodiments of the present disclosure;

FIG. 4 is a schematic diagram of a render texture provided by some embodiments of the present disclosure;

FIG. 5 is a schematic diagram of a sticker base image provided by some embodiments of the present disclosure;

FIG. 6 is a schematic diagram of a target video provided by some embodiments of the present disclosure;

FIG. 7 is a schematic diagram of another target video provided by some embodiments of the present disclosure;

FIG. 8 is a schematic diagram of a video processing provided by some embodiments of the present disclosure;

FIG. 9 is a schematic diagram of an updated target video provided by some embodiments of the present disclosure;

FIG. 10 is a structural schematic diagram of a video processing device provided by some embodiments of the present disclosure;

FIG. 11 is a structural schematic diagram of an electronic apparatus provided by some embodiments of the present disclosure.

### DETAILED DESCRIPTION OF PREFERRED EMBODIMENTS

Embodiments of the present disclosure will be described in more detail below with reference to the accompanying drawings. Although some embodiments of the present disclosure are shown in the drawings, it should be understood that the present disclosure can be embodied in various forms and should not be construed as limited to the embodiments set forth here, but rather, these embodiments are provided for a more thorough and complete understanding of the present disclosure. It should be understood that the drawings and embodiments of the present disclosure are used only for illustrative purposes, and are not used to limit the protection scope of the present disclosure.

It should be understood that steps described in the method embodiments of the present disclosure may be executed in different sequences and/or in parallel. Further, method embodiments may comprise additional steps and/or omit execution of illustrated steps. Scope of the present disclosure is not limited in this respect.

As used herein, the term “comprising” and its variants are open-ended including, that is, “including but not limited to”. The term “based on” is “at least partially based on”. The term “one embodiment” means “at least one embodiment”; the term “another embodiment” means “at least one other embodiment”; the term “some embodiments” means “at least some embodiments”. Related definitions of other terms will be given in the below description.

It should be noted that such concepts as “first”, “second” etc. mentioned in the present disclosure are only used to distinguish different devices, modules or units, and are not used to limit the order or interdependence of functions performed by these devices, modules or units.

It should be noted that such modifiers as “a” and “a plurality” mentioned in this disclosure are schematic rather than limiting, and those skilled in the art should understand that unless the context clearly indicates otherwise, they should be understood as “one or more”.

Names of messages or information exchanged among multiple devices in the embodiments of the present disclosure are only used for illustrative purposes, and are not used to limit the scope of these messages or information.

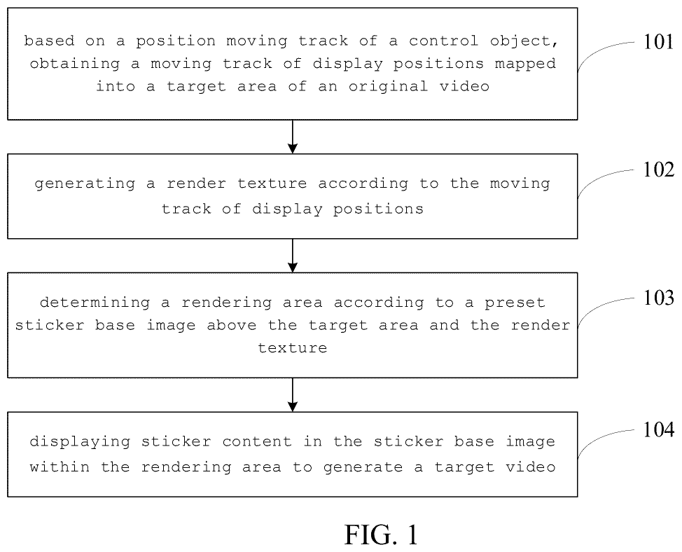

FIG. 1 is a flow chart of a video processing method provided by some embodiments of the present disclosure. The method can be executed by a video processing device, wherein the device can be implemented by software and/or hardware, and can be generally integrated in an electronic apparatus. As shown in FIG. 1, the method comprises: step 101: obtaining a moving track of display positions mapped into a target area of an original video, based on a moving track of positions of a control object.

The control object can be a preset body portion of a user, for example, the control object can comprise the user's fingers, nose, eyes, mouth, etc., which can be determined particularly according to the actual situation. The position moving track can be a moving track obtained by connecting positions of the control object at each moment in series. The original video can be a real-time video comprising part or all of the user's body portions collected by the current apparatus, and the original video can comprise the user, background and other contents, but it is not limited particularly thereto.

In some embodiments, prior to step 101, the video processing method may further comprise setting a target area in the original video, wherein the target area comprises a face area, a neck area, a clothes area, or a hair area. The target area may be an interactive attention area or an interactive area with the user in the original video, and the target area may be an area with a regular shape, such as a rectangular area, and the embodiments of the present disclosure does not impose limitations on the target area. For example, the target area may comprise, but is not limited to, a face area, a neck area, a clothes area, a hair area, a limbs area and so on. The target area can be set as actually needed, which improves the flexibility of the interaction area and further enhances the richness and interest of the subsequent interaction.

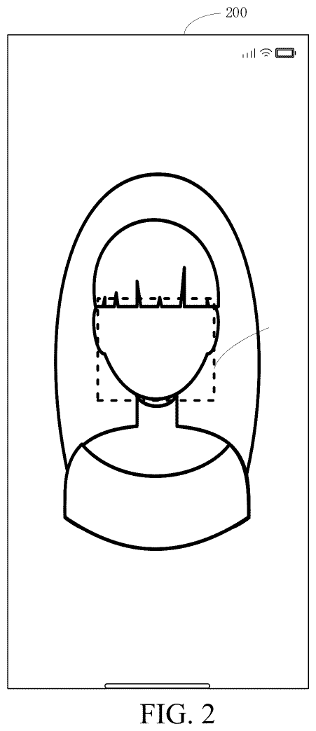

For example, FIG. 2 is a schematic diagram of a target area provided by some embodiments of the present disclosure. As shown in FIG. 2, a video image 200 of the original video is displayed, the video image 200 comprises a target area 201, and the target area refers to a face area in the figure, as an example only.

The moving track of display positions can be a trajectory of the position moving track of the control object in a space that is mapped to a display screen, and the trajectory can be mapped to the target area of the original video since the original video is displayed on the display screen. In the embodiments of the present disclosure, the moving track of display positions may be all the positions of the target area, or the moving track of display positions may be part of the positions of the target area, which is not specifically limited.

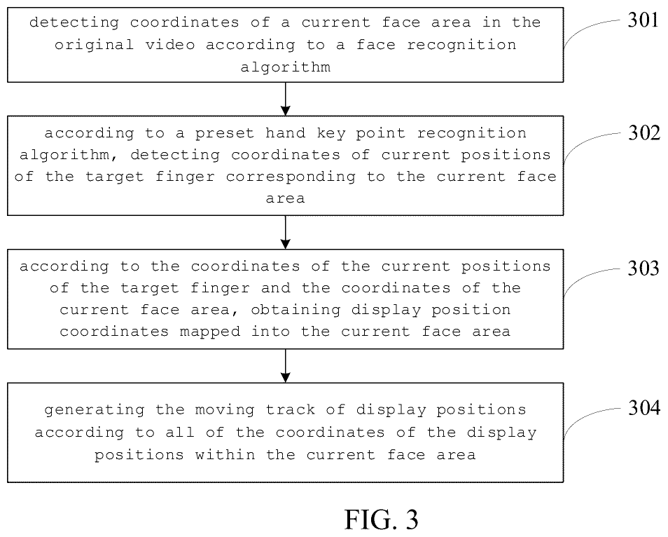

For example, FIG. 3 is a flow chart of another video processing method provided by some embodiments of the present disclosure. As shown in FIG. 3, in a feasible implementation, in responds to that the target area is a face area and the control object is a target finger, wherein the step 101 may comprise the following step.

Step 301: detecting coordinates of the current face area in the original video according to a face recognition algorithm.

The face recognition algorithm can be any algorithm that can recognize the face area in the image, but it is not limited particularly thereto. In the embodiments of the present disclosure, taking the face area as a rectangular area comprising a face as an example, the current face area may be a rectangular area comprising the current face, and the coordinates of the current face area may comprise a width, a height and lower left corner coordinates of the current face area corresponding to the screen.

In particular, after a client collects an original video, a recognition processing can be made to real-time images in the original video through the face recognition algorithm, to determine coordinates of the current face area in each real-time image in the original video.

Step 302: according to a preset hand key point recognition algorithm, detecting coordinates of current positions of the target finger relative to the current face area.

The target finger may be one of a plurality of fingers of the user, but it is not particularly limited thereto. For example, the target finger may be the index finger of the left hand. The hand key point recognition algorithm can be an algorithm that identifies the preset hand key points based on images, and the number of hand key points can be set according to the actual situation.

In particular, the client recognizes the real-time image comprising the target finger in the original video by using the hand key point recognition algorithm, so as to determine the coordinates of the hand key point corresponding to the target finger, with the lower left corner of the current face area as the coordinate origin, as the coordinates of the current positions of the target finger.

Step 303: according to the coordinates of the current positions of the target finger and the coordinates of the current face area, obtaining display position coordinates mapped into the current face area.

After determining the coordinates of the current positions of the target finger relative to the current face area and the coordinates of the current face area relative to the screen, the client can map the coordinates of the current positions of the target finger to the screen and determine display position coordinates of the target finger mapped to the current face area, that is, the display position coordinates of the target finger relative to the screen.

In some embodiments, the obtaining display position coordinates mapped into the current face area according to the coordinates of the current positions of the target finger and the coordinates of the current face area, comprises: determining a coordinate ratio of the target finger within the current face area according to the coordinates of the current positions of the target finger and the coordinates of the current face area; determining whether the coordinates of the current positions of the target finger are mapped into the current face area according to the coordinate ratio and a preset mapping relationship; in response to that the coordinates of the current positions of the target finger are mapped into the current face area, obtaining display position coordinates mapped into the current face area according to the coordinate ratio.

The coordinate ratio of the target finger within the current face area can comprise a coordinate ratio of an x-axis and a coordinate ratio of a y-axis. The preset mapping relationship can represent a positive or negative coordinate ratio of the target finger when the target finger is within the current face area. When the coordinate ratio is greater than or equal to zero, it represents that the target finger is within the current face area; otherwise, it represents that the target finger is not within the current face area.

Since the coordinates of the current positions of the target finger take the lower left corner of the current face area as the coordinate origin, assuming that the lower left corner coordinates of the current face area are (x2, y2), with a width w1 and a height h1, taking the lower left corner coordinates (x2, y2) as the origin, and that the coordinates of the current positions of the target finger are (x1, y1), then, the coordinate ratio of the x-axis of the coordinate ratio of the target finger within the current face area is x1/w1, and the coordinate ratio of the y axis is y1/h1; thereafter, the client can determine whether the coordinate ratio is positive or negative: when the target finger is not within the current face area, x1 and/or y1 are negative, and the coordinate ratio is negative, and when the target finger is within the current face area, x1 and y1 are both positive, and the coordinate ratio is also positive; when it is determined that the coordinate ratio is positive, it is determined that the coordinates of the current positions of the target finger are mapped into the current face area, whereby the coordinates of the current positions of the target finger can be scaled to the screen according to the coordinate ratio to obtain the corresponding display position coordinates. Assuming that the width of the screen is w2 and the height is h2, the display position coordinates of the target finger are expressed as (x3, y3), x3=w2*x1/w1, y3=h2*y1/h1.

In the above solution, when determining the display position coordinates of the target finger mapped into the current face area, the face area can be used as a scaled-down screen, and the coordinates of the current positions of the target finger corresponding to the current face area can be scaled up to the screen to determine the display position coordinates, so that the display position coordinates of the target finger can be quickly determined.

In some other embodiments, the client can also directly obtain the display position coordinates of the screen corresponding to the target finger, and determine whether the target finger is within the current face area according to the coordinates of the current face area corresponding to the screen, if so, subsequent steps can be directly executed.

Step 304: generating a moving track of display positions according to all of the coordinates of the display positions within the current face area.

In particular, for the original video, after determining all of the coordinates of the display positions of the target finger within the current face area, the client can connect all of the coordinates in series as the moving track of display positions.

Step 102: generating a render texture according to the moving track of display positions.

The render texture can be understood as a bearing object of doodling effect generated according to an action of the user for the control object.

In some embodiments, the generating a render texture according to the moving track of display positions, may comprise: calling a preset circular picture to draw a dot to represent each of the display positions among the moving track, to form a plurality of dots; and calling a preset rectangular picture to fill in gaps between adjacent dots of the plurality of dots, to generate the render texture.

Since the original video can comprise a plurality of image frames, each image frame corresponds to coordinates of each display position, and the moving track of display positions comprises coordinates of display positions of a plurality of image frames, when the client generates the render texture according to the moving track of display positions, the client can draw preset circular pictures on coordinates of each display position one by one to form dots, and each time the dot is drawn, the dot can be save as a dot drawn in history, so that a plurality of continuous dots can be formed, and gaps exist between adjacent dots; thereafter, for the gaps between adjacent dots of a plurality of dots, the client can calculate a distance of each gap, and use a preset rectangular picture to fill in each gap with a constant width and a length scaled to the gap distance, to form a path. Finally, render the dots and the paths between adjacent dots filled with rectangles in a transparent canvas to obtain a render texture.

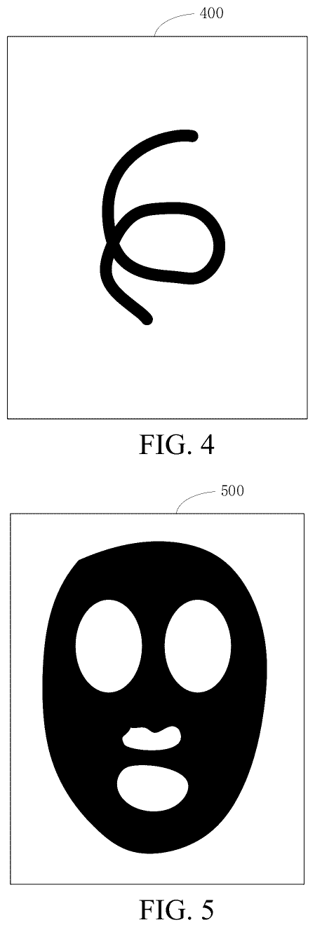

For example, FIG. 4 is a schematic diagram of a render texture provided by some embodiments of the present disclosure. As shown in FIG. 4, a render texture 400 is displayed, which comprises a plurality of dots corresponding to the moving track of display positions and the paths between adjacent dots filled with rectangles. It is only an example shown in the figure rather than limitation.

Step 103: determining a rendering area according to a preset sticker base image above the target area and the render texture.

The sticker base image can be an image with a preset material, preset color and/or preset texture set in advance for the target area, the sticker base image may be sized the same as the target area, and the material or color of the sticker base image can be set according to actually need, which is not limited by the embodiments of the present disclosure. For example, when the target area is a face area, the sticker base image can be an image with a face mask material and a pink color.

In some embodiments, in response to that the target area is a face area, the determining a rendering area according to a preset sticker base image above the target area and the render texture, may comprise: determining a face grid corresponding to the face area according to the face key point algorithm, and setting the sticker base image above the face grid; calculating corresponding positions between the sticker base image and the render texture, and selecting overlapping positions of the sticker base image and the render texture according to a result of the calculating, and determining the overlapping positions as the rendering area.

In particular, taking that the target area is a face area as an example, for a real-time image in the original video, the client can recognize the real-time image by using the face key point recognition algorithm and carry out three-dimensional reconstruction to obtain a face grid corresponding to the face area, and dispose the preset sticker base image above the face grid, wherein the sticker base image is sized to be the same as the face grid, but the sticker base image is not displayed; thereafter, the render texture determined in the above step can be added to the sticker base image, and the overlapping positions can be determined according to the coordinates of the sticker base image and the coordinates of the moving track of display positions in the render texture, and the overlapping positions are determined as the rendering area.

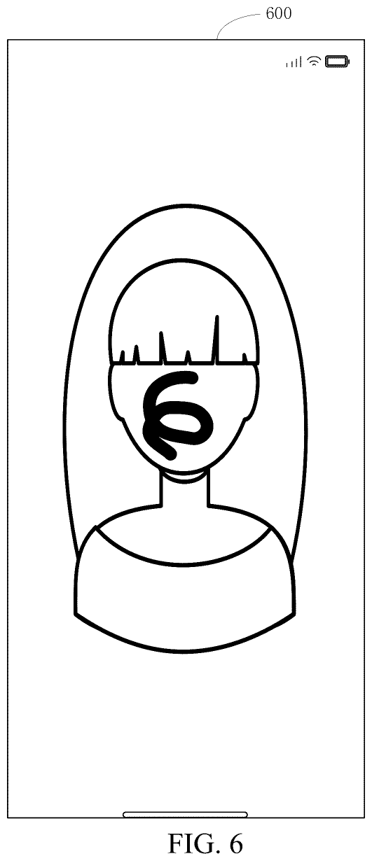

For example, FIG. 5 is a schematic diagram of a sticker base image provided by some embodiments of the present disclosure. As shown in FIG. 5, a sticker base image when the target area is a face area, is displayed, and the sticker base image is similar to a mask, and has a color that is set to black, as an example only.

Step 104: displaying sticker content in the sticker base image within the rendering area to generate a target video.

The rendering area can be understood as an area where doodling effect is displayed.

In the embodiments of the present disclosure, after the rendering area is determined, in each real-time image of the original video, the sticker content of the sticker base image can be displayed within the rendering area part, while the part other than the rendering area remains in the original state to obtain the target video.

Since it is the sticker content corresponding to the moving track of display positions of the control object that is displayed within the rendering area, it is allowed that, when action of the control object acts on the target area from a distance in space, the preset sticker content can be displayed along with action track of the control object, that is, the doodling effect can be displayed from a distance, which improves the flexibility and intensity of interaction.

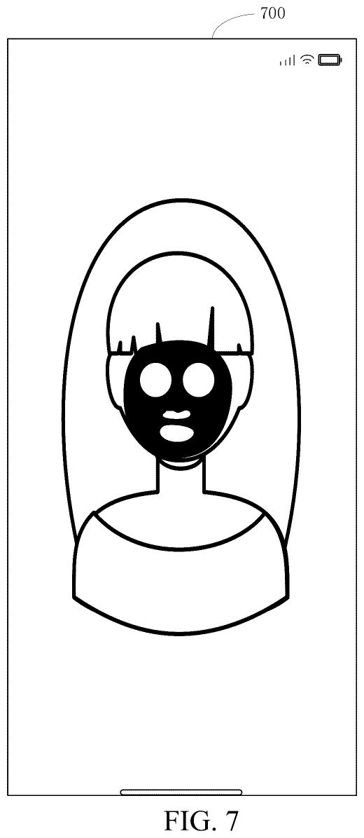

For example, FIG. 6 is a schematic diagram of a target video provided by some embodiments of the present disclosure. As shown in FIG. 6, an image frame 600 of a target video is displayed. In the image frame 600, the sticker content corresponding to the moving track of display positions shown in FIG. 4 can be displayed within the face area, the moving track of display positions is part of the position of the face area, and the sticker content here is filled with black. For example, FIG. 7 is a schematic diagram of another target video provided by some embodiments of the present disclosure. As shown in FIG. 7, an image frame 700 of a target video is displayed. In the image frame 700, the moving track of display positions is all the position of the face area, so that the whole face area is the rendering area, and the black-filled sticker base image is completely displayed. The above-mentioned FIGS. 6 and 7 are only examples, rather than limitation.

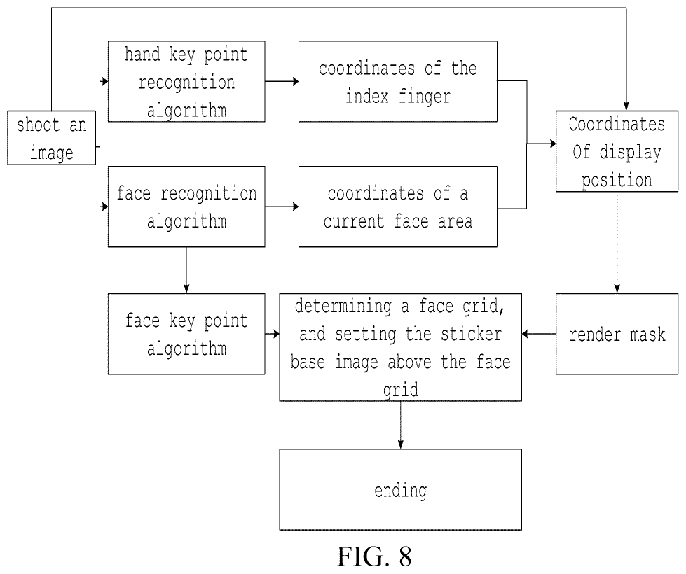

For example, FIG. 8 is a schematic diagram of a video processing provided by some embodiments of the present disclosure. As shown in FIG. 8, a complete process of video processing is displayed. Taking that the target area is a face area and the control object is an index finger, as an example, the process may particularly comprise: capturing an original video by the client, the original video comprising a plurality of image frames, and a shot image in the figure can be one image frame; for each image frame, obtaining coordinates of the current face area by the face recognition algorithm, which can comprise a width a height and coordinates of a lower left corner, and obtaining coordinates of the current positions “hand” of the index finger corresponding to the position of the current face area by the hand key point recognition algorithm; when coordinates “hand” are within the current face area, mapping it to coordinates of display position “screen”, by using the coordinate ratio of “hand” within the current face area and screen coordinates “screenrect”, wherein the current face area can be regarded as a zoom-down screen, and the screen coordinates can comprise the width and height of the screen by zoom-up “hand” at an equal ratio into the “screenrect” as the “screen”; generating a moving track of display positions according to the coordinates of the display position, and then drawing with preset circular images and rectangular images to obtain a render texture; at the same time, determining a face grid by using the face recognition algorithm and face key point algorithm, and adding the preset sticker base image of the face area to the face grid; applying the render texture to the sticker base image as a mask, and determining an overlapping area between the render texture and the sticker base image as a rendering area, and displaying sticker content of the sticker base image within the rendering area. The rendering area is a part doodled by the index finger, and a finally shown effect is that, when the user's index finger acts on the face, the face area acted on by the index finger will be doodled as the preset sticker content.

According to the video processing solution provided by the embodiments of the present disclosure, based on the position moving track of the control object, obtaining a moving track of display positions mapped into the target area of the original video; generating a render texture according to the moving track of display positions; determining a rendering area according to a preset sticker base image above the target area and the render texture; displaying sticker content in the sticker base image within the rendering area to generate a target video. According to the above technical solution, when the control object is mapped to the target area of the original video, the corresponding moving track of display positions can be obtained by recognizing the position moving track of the control object, and the rendering area can be determined based on the render texture and the sticker base image generated according to the moving track of display positions, and the target video can be obtained by displaying the sticker base image within the rendering area of the original video, such that when action of the control object acts on the target area of the video, doodling effect can be displayed in the area corresponding to the action, and the action is not limited to the screen range, which improves the flexibility and intensity of interaction, thus enhancing the richness and interest of interaction and improving the interactive experience effect of users.

In some embodiments, after the displaying sticker content in the sticker base image within the rendering area to generate a target video, the video processing method may further comprise displaying the original video content within the rendering area in response to a first scene feature satisfying a preset sticker display ending condition.

The first scene feature can be a current preset type of scene information, such as display duration, a current location, etc., which is not limited particularly. The sticker display ending condition can be set based on features of the first scene, and can be set according to the actual situation. For example, the sticker display ending condition can be that the display duration reaches a preset time, the current location is a preset location or the like.

In particular, the client can obtain the current first scene feature and determine whether the first scene feature meets the sticker display ending condition, and if the first scene feature meets the sticker display ending condition, the client can close the sticker content displayed within the rendering area and display the content of the original video within the rendering area.

In the above solution, the display of doodling effect can be turned off under specific scene condition. This is more in line with the actual application scene of users and further improves the flexibility of effect display.

In some embodiments, after displaying sticker content in the sticker base image within the rendering area to generate a target video, the video processing method may further comprise displaying the original video content within the rendering area in response to a second scene feature meeting a preset sticker moving condition; and determining an updated rendering area after a movement on the original video according to the second scene feature, and displaying sticker content in the sticker base image in the updated rendering area to generate an updated target video.

The second scene feature can be scene information different from the above-mentioned first scene feature, for example, the second scene feature can comprise a current trigger operation of the user. The sticker moving condition can be a condition that a display position of the sticker content needs to be moved based on the second scene feature, and can be set according to the actual situation. For example, the sticker moving condition can be that the current trigger operation is a preset trigger operation, and the preset trigger operation can comprise gesture control operation, voice control operation or expression control operation, etc., which is not limited particularly. For example, the preset trigger operation can be a movement of the above-mentioned control object or a blowing operation performed by a mouth area. The updated rendering area can be an area where the sticker content is determined to be displayed according to the second scene feature.

In particular, the client can obtain the current second scene feature and determine whether the second scene feature meets the sticker moving condition, if the second scene feature meets the sticker moving condition, the client can close the sticker content displayed within the rendering area and display the content of the original video within the rendering area; and determine the updated rendering area on the original video according to the second scene feature, and display the sticker content within the updated rendering area in the sticker base image, so as to obtain the target video with a changed display position of the sticker content.

For example, when the second scene feature is the movement of the control object, the determining the updated rendering area on the original video according to the second scene feature may comprise: determining a moving distance and a moving direction of the control object, and determining an area where the rendering area moved by the moving distance in the moving direction as the updated rendering area.

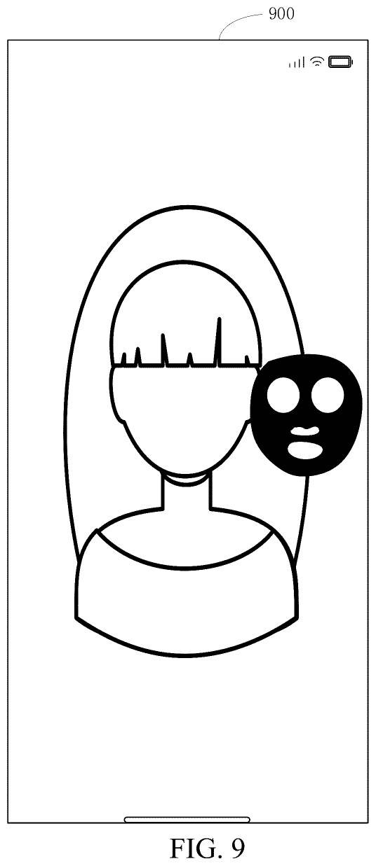

For example, FIG. 9 is a schematic diagram of an updated target video provided by some embodiments of the present disclosure. As shown in FIG. 9, an image frame 900 of an updated target video is displayed. As compared to FIG. 7, the updated rendering area in the image frame 900 moves to the right relative to the rendering area in FIG. 7. Instead of in the face area, the black-filled sticker content is displayed in the updated rendering area.

In the above solution, in a specific scene, the rendering area can move according to need of the user. This provides more interactive ways and further improves the interactive flexibility.

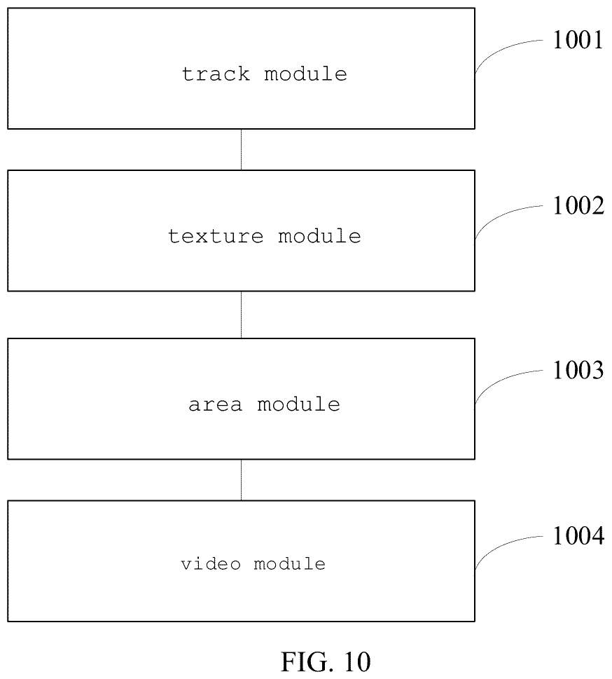

FIG. 10 is a structural schematic diagram of a video processing device provided by some embodiments of the present disclosure. The device can be implemented by software and/or hardware, and can be generally integrated in an electronic apparatus. As shown in FIG. 10, the device comprises: a track module 1001 configured to, based on a position moving track of a control object, obtain a moving track of display positions mapped into a target area of an original video; a texture module 1002 configured to generate a render texture according to the moving track of display positions; an area module 1003 configured to determine a rendering area according to a preset sticker base image above the target area and the render texture; a video module 1004 configured to display sticker content in the sticker base image within the rendering area to generate a target video.

In some embodiments, the device further comprises an area setting module, configured to: set the target area in the original video, wherein the target area comprises a face area, a neck area, a clothes area, or a hair area.

In some embodiments, the moving track of display positions may be all positions of the target area, or the moving track of display positions may be part of the positions of the target area.

In some embodiments, in response to that the target area is a face area and the control object is a target finger, the track module 1001 comprises: a face unit configured to detect coordinates of a current face area in the original video according to a face recognition algorithm; a finger unit configured to, according to a preset hand key point recognition algorithm, detect coordinates of the current positions of the target finger corresponding to the current face area; a coordinate unit is configured to, according to the coordinates of the current positions of the target finger and the coordinates of the current face area, obtain display position coordinates mapped into the current face area; a determining unit configured to, generate the moving track of display positions according to all of the coordinates of the display positions within the current face area.

In some embodiments, the coordinate unit is configured to:

according to the coordinates of the current positions of the target finger and the coordinates of the current face area, determine a coordinate ratio of the target finger within the current face area; determine whether the coordinates of the current positions of the target finger are mapped into the current face area according to the coordinate ratio and a preset mapping relationship;
in response to that they are mapped into the current face area, obtain display position coordinates mapped into the current face area according to the coordinate ratio.

In some embodiments, the texture module 1002 is configured to: call a preset circular picture to draw a dot to represent each of the display positions among the moving track; and call a preset rectangular picture to fill in gaps between adjacent dots of the plurality of dots, to generate the render texture.

In some embodiments, in condition that the target area is a face area, the area module 1003 is configured to: determine a face grid corresponding to the face area according to a face key point algorithm, and set the sticker base image above the face grid; calculate corresponding positions between the sticker base image and the render texture, and select overlapping positions of the sticker base image and the render texture according to a result of the calculating, and determining the overlapping positions as the rendering area.

In some embodiments, the device further comprises an ending module configured to, after displaying sticker content in the sticker base image within the rendering area to generate a target video; display the original video content within the rendering area in response to a first scene feature satisfying a preset sticker display ending condition.

In some embodiments, the device further comprises a moving module configured to, after displaying sticker content in the sticker base image within the rendering area to generate a target video, display the original video content within the rendering area in response to a second scene feature satisfying a preset sticker moving condition; and determine an updated rendering area after a movement on the original video according to the second scene feature, and display sticker content in the sticker base image in the updated rendering area to generate an updated target video.

The video processing device provided by some embodiments of the present disclosure can execute the video processing method provided by any embodiment of the present disclosure, and has corresponding functional modules and advantageous effect.

The above modules or units may be implemented as software components executed on one or more general-purpose processors, or as hardware such as programmable logic devices and/or application-specific integrated circuits that perform certain functions or combinations thereof. In some embodiments, these modules or units may be embodied in the form of software products, which may be stored in non-volatile storage media, and these non-volatile storage media comprise methods that enable computer devices (such as personal computers, servers, network devices, mobile terminals, etc.) to implement the methods described in the embodiments of the present disclosure. In some other embodiments, the above modules or units can also be implemented on a single device or distributed on multiple devices. Functions of these modules or units can be combined with each other or further split into multiple sub-units.

Some embodiments of the present disclosure further provide a computer program product comprising a computer program/instruction which, when executed by a processor, implement the video processing method provided by any embodiment of the present disclosure.

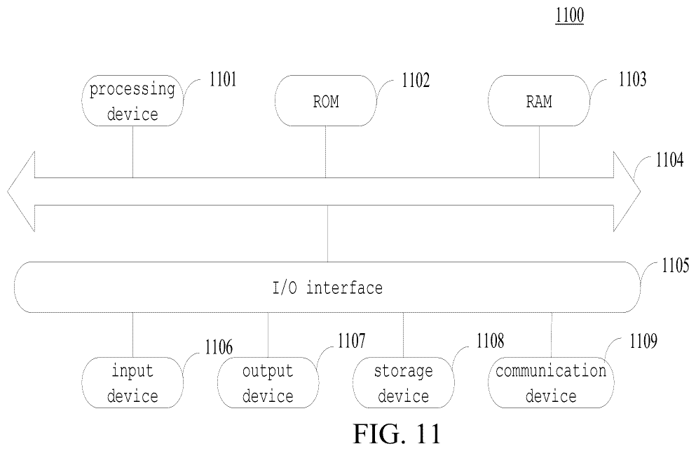

FIG. 11 is a structural schematic diagram of an electronic apparatus provided by some embodiments of the present disclosure. Referring specifically to FIG. 11, there is shown a structural schematic diagram of an electronic apparatus 1100 adapted for implementing some embodiments of the present disclosure. The electronic apparatus 1100 in the embodiments of the present disclosure may comprise, but is not limited to, a mobile terminal such as a mobile phone, a notebook computer, a digital broadcast receiver, a PDA (Personal Digital Assistant), a PAD (Tablet Computer), a PMP (Portable Multimedia Player), a vehicle-mounted terminal (such as a vehicle-mounted navigation terminal) and the like, and a fixed terminal such as a digital TV, a desktop computer and the like. The electronic apparatus shown in FIG. 11 is only an example, and should not be construed to limit function and application scope of the embodiments of the present disclosure.

As shown in FIG. 11, an electronic apparatus 1100 may comprise a processing device (e.g., a central processor, a graphics processor, etc.) 1101, which may perform various appropriate actions and processes according to a program stored in a read-only memory (ROM) 1102 or a program loaded into a random access memory (RAM) 1103 from a storage device 1108. In the RAM 1103, various programs and data required for operation of the electronic apparatus 1100 are also stored. The processing device 1101, the ROM 1102 and the RAM 1103 are connected to each other through a bus 1104. An input/output (I/O) interface 1105 is also connected to the bus 1104.

Generally, the following devices can be connected to the I/O interface 1105: an input device 1106 comprising, for example, a touch screen, a touch pad, a keyboard, a mouse, a camera, a microphone, an accelerometer, a gyroscope, etc.; an output device 1107 comprising, for example, a liquid crystal display (LCD), a speaker, a vibrator, etc.; a storage device 1108 comprising, for example, a magnetic tape, a hard disk, etc.; and a communication device 1109. The communication device 1109 may allow the electronic apparatus 1100 to communicate wirelessly or wired with other devices to exchange data. Although FIG. 11 shows an electronic apparatus 1100 with various devices, it should be understood that it is not required to implement or have all the devices shown. More or fewer devices may alternatively be implemented or provided.

In particular, according to some embodiments of the present disclosure, the process described above with reference to the flowchart can be implemented as a computer software program. For example, the embodiments of the present disclosure comprise a computer program product comprising a computer program carried on a non-transient computer-readable medium, the computer program comprising program code for executing the method shown in the flow chart. In some embodiments, the computer program can be downloaded and installed from the network through the communication device 1109, or installed from the storage device 1108, or installed from the ROM 1102. When the computer program is executed by the processing device 1101, the above function defined in the video processing method of the embodiments of the present disclosure is performed.

It should be noted that the computer-readable medium mentioned above in this disclosure can be a computer-readable signal medium or a computer-readable storage medium or any combination thereof. The computer-readable storage medium can be, for example, but not limited to, an electrical, magnetic, optical, electromagnetic, infrared, or semiconductor system, device or unit, or any combination of the above. More examples of computer-readable storage media may comprise, but are not limited to, an electrical connection with one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the above. In the present disclosure, a computer-readable storage medium can be any tangible medium containing or storing a program, which program can be used by or in combination with an instruction execution system, device or unit. In the present disclosure, a computer-readable signal medium may comprise a data signal propagated in baseband or as part of a carrier wave, in which computer-readable program code is carried. This propagated data signal can take many forms, comprising but not limited to an electromagnetic signal, an optical signal or any suitable combination of the above. A computer-readable signal medium can also be any computer-readable medium other than a computer-readable storage medium, which can send, propagate or transmit a program for use by or in connection with an instruction execution system, device or unit. Program code contained in the computer-readable medium can be transmitted by any suitable medium, comprising but not limited to: a wire, an optical cable, a RF (radio frequency) and the like, or any suitable combination of the above.

In some embodiments, the client and the server can communicate by using any currently known or future developed network protocol such as HTTP (HyperText Transfer Protocol), and can be interconnected with digital data communication in any form or medium (for example, communication network). Examples of communication network comprise a local area network (“LAN”), a wide area network (“WAN”), an internet (for example, the Internet) and an end-to-end network (for example, ad hoc end-to-end network), as well as any currently known or future developed network.

The computer-readable medium may be comprised in the electronic device; or it can exist independently without being assembled into the electronic device.

The computer-readable medium carries one or more programs that, when executed by the electronic apparatus, cause the electronic apparatus to: based on the position moving track of the control object, obtain a moving track of display positions mapped into the target area of the original video; generate a render texture according to the moving track of display positions; determine a rendering area according to a preset sticker base image above the target area and the render texture; display sticker content in the sticker base image within the rendering area to generate a target video.

Computer program codes for performing operations of the present disclosure may be written in one or more programming languages or their combinations, comprising but not limited to object-oriented programming languages, such as Java, Smalltalk, C++, and conventional procedural programming languages, such as “C” language or similar programming languages. The program code can be completely executed on the user's computer, partially executed on the user's computer, executed as an independent software package, partially executed on the user's computer and partially executed on a remote computer, or completely executed on a remote computer or server. In the case involving a remote computer, the remote computer may be connected to a user computer through any kind of network, comprising a local area network (LAN) or a wide area network (WAN), or may be connected to an external computer (for example, through the Internet using an Internet service provider).

The flowcharts and block diagrams in the drawings illustrate the architecture, functions and operations of possible implementations of systems, methods and computer program products according to various embodiments of the present disclosure. In this regard, each block in the flowchart or block diagram may represent a module, a program segment, or part of codes that contains one or more executable instructions for implementing a specified logical function. It should also be noted that in some alternative implementations, the function noted in the block may occur in a different order than that noted in the drawing. For example, two blocks shown in succession may actually be executed substantially in parallel, and they may sometimes be executed in the reverse order, depending on the functions involved. It should also be noted that each block in the block diagrams and/or flowcharts, and combinations of blocks in the block diagrams and/or flowcharts, can be implemented by a dedicated hardware-based system that performs specified functions or operations, or by a combination of dedicated hardware and computer instructions.

Units involved in the embodiments described in the present disclosure can be realized by software or hardware. Names of units do not constitute limitation of the units themselves in some cases.

Functions described above herein may be at least partially performed by one or more hardware logic components. For example, without limitation, exemplary types of hardware logic components that can be used comprise: Field Programmable Gate Array (FPGA), Application Specific Integrated Circuit (ASIC), Application Specific Standard Product (ASSP), System on Chip (SOC), Complex Programmable Logic Device (CPLD) and so on.

In the context of the present disclosure, a machine-readable medium may be a tangible medium that may contain or store a program for use by or in connection with an instruction execution system, device or apparatus. The machine-readable medium may be a machine-readable signal medium or a machine-readable storage medium. A machine-readable medium may comprise, but is not limited to, an electronic, magnetic, optical, electromagnetic, infrared, or semiconductor system, device or apparatus, or any suitable combination of the above. More specific examples of the machine-readable storage medium may comprise an electrical connection based on one or more lines, a portable computer disk, a hard disk, a random access memory (RAM), a read-only memory (ROM), an erasable programmable read-only memory (EPROM or flash memory), an optical fiber, a convenient compact disk read-only memory (CD-ROM), an optical storage apparatus, a magnetic storage apparatus, or any suitable combination of the above.

According to some embodiments of the present disclosure, there is provided a computer program, comprising an instruction that, when executed by a processor, causes the processor to implement the video processing method according to any one of the embodiments of the present disclosure.

The above description is only the preferred embodiments of the present disclosure and the explanation of the applied technical principles. It should be understood by those skilled in the art that the disclosed scope involved in the present disclosure is not limited to technical solutions formed by specific combinations of the above technical features, but also covers other technical solutions formed by any combinations of the above technical features or their equivalent features without departing from the above disclosed concept, such as technical solutions formed by replacing the above features with (but not limited to) technical features with similar functions disclosed in the present disclosure.

Furthermore, although operations are depicted in a particular order, this should not be understood as requiring that these operations be performed in the particular order shown or in a sequential order. In a determined circumstance, multitasking and parallel processing may be advantageous. Likewise, although several specific implementation details are contained in the above discussion, these should not be construed as limiting the scope of the present disclosure. Some features described in the context of separate embodiments can also be combined in a single embodiment. On the contrary, various features described in the context of a single embodiment can also be implemented in multiple embodiments individually or in any suitable sub-combination.

Although the subject matter has been described in language specific to structural features and/or methodological logical actions, it should be understood that the subject matter defined in the appended claims is not necessarily limited to the specific features or actions described above. On the contrary, specific features and actions described above are only exemplary forms of implementing the claims.

1. A video processing method, comprising:
obtaining a moving track of display positions mapped into a target area of an original video, based on a moving track of positions of a control object;
generating a render texture according to the moving track of the display positions;
determining a rendering area according to a preset sticker base image above the target area and the render texture; and
displaying sticker content in the sticker base image within the rendering area to generate a target video.

2. The video processing method according to claim 1, further comprising:
setting the target area in the original video, wherein the target area comprises a face area, a neck area, a clothes area, or a hair area.

3. The video processing method according to claim 1, wherein the moving track of the display positions comprises all positions of the target area, or the moving track of the display positions comprises part of the positions of the target area.

4. The video processing method according to claim 1, wherein the obtaining the moving track of the display positions mapped into the target area of the original video, based on the moving track of the positions of the control object, comprises:
in response to that the target area is a face area and the control object is a target finger, detecting coordinates of a current face area in the original video according to a face recognition algorithm;
detecting coordinates of current positions of the target finger corresponding to the current face area, according to a preset hand key point recognition algorithm;
obtaining coordinates of the display positions mapped into the current face area, according to the coordinates of the current positions of the target finger and the coordinates of the current face area; and
generating the moving track of the display positions according to all of the coordinates of the display positions within the current face area.

5. The video processing method according to claim 4, wherein the obtaining the coordinates of the display positions mapped into the current face area, according to the coordinates of the current positions of the target finger and the coordinates of the current face area, comprises:
determining a coordinate ratio of the target finger within the current face area, according to the coordinates of the current positions of the target finger and the coordinates of the current face area;
determining whether the coordinates of the current positions of the target finger are mapped into the current face area, according to the coordinate ratio and a preset mapping relationship; and
in response to that the coordinates of the current positions of the target finger are mapped into the current face area, obtaining the coordinates of the display positions mapped into the current face area according to the coordinate ratio.

6. The video processing method according to claim 1, wherein the generating the render texture according to the moving track of the display positions, comprises:
calling a preset circular picture to draw a dot to represent each of the display positions among the moving track, to form a plurality of dots; and
calling a preset rectangular picture to fill in gaps between adjacent dots of the plurality of dots, to generate the render texture.

7. The video processing method according to claim 1, wherein the determining the rendering area according to the preset sticker base image above the target area and the render texture, comprises:
in response to that the target area is a face area, determining a face grid corresponding to the face area according to the face key point algorithm, and setting the sticker base image above the face grid; and
calculating corresponding positions between the sticker base image and the render texture;
selecting overlapping positions between the sticker base image and the render texture, according to a result of the calculating; and
determining the overlapping positions as the rendering area.

8. The video processing method according to claim 1, further comprising:
displaying original video content within the rendering area, in response to a first scene feature satisfying a preset sticker display ending condition, after the displaying the sticker content in the sticker base image within the rendering area to generate the target video.

9. The video processing method according to claim 1, further comprising:
displaying original video content within the rendering area in response to a second scene feature satisfying a preset sticker moving condition, after the displaying the sticker content in the sticker base image within the rendering area to generate the target video;
determining an updated rendering area after a movement on the original video according to the second scene feature; and
displaying the sticker content in the sticker base image within the updated rendering area to generate an updated target video.

10-17. (canceled)

18. An electronic apparatus, comprising:
a processor;
a memory for storing an instruction executable by the processor;
wherein the processor is configured to read the executable instruction from the memory and execute the instruction to implement the video processing method, comprising:
obtaining a moving track of display positions mapped into a target area of an original video, based on a moving track of positions of a control object;
generating a render texture according to the moving track of the display positions;
determining a rendering area according to a preset sticker base image above the target area and the render texture; and
displaying sticker content in the sticker base image within the rendering area to generate a target video.

19. A non-transitory computer-readable storage medium in which an instruction of a computer program is stored, and the instruction is configured to execute the video processing method, comprising:
obtaining a moving track of display positions mapped into a target area of an original video, based on a moving track of positions of a control object;
generating a render texture according to the moving track of the display positions;
determining a rendering area according to a preset sticker base image above the target area and the render texture; and
displaying sticker content in the sticker base image within the rendering area to generate a target video.

20. (canceled)

21. The electronic apparatus according to claim 18, further comprising:
setting the target area in the original video, wherein the target area comprises a face area, a neck area, a clothes area, or a hair area.

22. The electronic apparatus according to claim 18, wherein the moving track of the display positions comprises all positions of the target area, or the moving track of the display positions comprises part of the positions of the target area.

23. The electronic apparatus according to claim 18, wherein the obtaining the moving track of the display positions mapped into the target area of the original video, based on the moving track of the positions of the control object, comprises:
in response to that the target area is a face area and the control object is a target finger, detecting coordinates of a current face area in the original video according to a face recognition algorithm;
detecting coordinates of current positions of the target finger corresponding to the current face area, according to a preset hand key point recognition algorithm;
obtaining coordinates of the display positions mapped into the current face area, according to the coordinates of the current positions of the target finger and the coordinates of the current face area; and
generating the moving track of the display positions according to all of the coordinates of the display positions within the current face area.

24. The electronic apparatus according to claim 23, wherein the obtaining the coordinates of the display positions mapped into the current face area, according to the coordinates of the current positions of the target finger and the coordinates of the current face area, comprises:
determining a coordinate ratio of the target finger within the current face area, according to the coordinates of the current positions of the target finger and the coordinates of the current face area;
determining whether the coordinates of the current positions of the target finger are mapped into the current face area, according to the coordinate ratio and a preset mapping relationship; and
in response to that the coordinates of the current positions of the target finger are mapped into the current face area, obtaining the coordinates of the display positions mapped into the current face area according to the coordinate ratio.

25. The non-transitory computer-readable storage medium according to claim 19, further comprising:
setting the target area in the original video, wherein the target area comprises a face area, a neck area, a clothes area, or a hair area.

26. The non-transitory computer-readable storage medium according to claim 19, wherein the moving track of the display positions comprises all positions of the target area, or the moving track of the display positions comprises part of the positions of the target area

27. The non-transitory computer-readable storage medium according to claim 19, wherein the obtaining the moving track of the display positions mapped into the target area of the original video, based on the moving track of the positions of the control object, comprises:
in response to that the target area is a face area and the control object is a target finger, detecting coordinates of a current face area in the original video according to a face recognition algorithm;
detecting coordinates of current positions of the target finger corresponding to the current face area, according to a preset hand key point recognition algorithm;
obtaining coordinates of the display positions mapped into the current face area, according to the coordinates of the current positions of the target finger and the coordinates of the current face area; and
generating the moving track of the display positions according to all of the coordinates of the display positions within the current face area.

28. The non-transitory computer-readable storage medium according to claim 27, wherein the obtaining the coordinates of the display positions mapped into the current face area, according to the coordinates of the current positions of the target finger and the coordinates of the current face area, comprises:
determining a coordinate ratio of the target finger within the current face area, according to the coordinates of the current positions of the target finger and the coordinates of the current face area;
determining whether the coordinates of the current positions of the target finger are mapped into the current face area, according to the coordinate ratio and a preset mapping relationship; and
in response to that the coordinates of the current positions of the target finger are mapped into the current face area, obtaining the coordinates of the display positions mapped into the current face area according to the coordinate ratio.

29. The non-transitory computer-readable storage medium according to claim 19, wherein the generating the render texture according to the moving track of the display positions, comprises:
calling a preset circular picture to draw a dot to represent each of the display positions among the moving track, to form a plurality of dots; and
calling a preset rectangular picture to fill in gaps between adjacent dots of the plurality of dots, to generate the render texture.
